(19) United States
(12) Patent Application Publication
(10) Pub. No.: US 2020/0187497 A1
(43) Pub. Date: Jun. 18, 2020

(54) CO-DEPOSITION PRODUCTS, COMPOSITE MATERIALS AND PROCESSES FOR THE PRODUCTION THEREOF

(71) Applicant: Exciton Pharma Corp., Edmonton (CA)

(72) Inventor: Carla Jehan Catherine SPINA, Toronto (CA)

(73) Assignee: Exciton Pharma Corp., Edmonton, AB (CA)

(21) Appl. No.: 16/263,589

(22) PCT Filed: Aug. 10, 2017
(86) PCT No.: PCT/CA2017/050944

§ 371 Date: Jan. 31, 2019

Related U.S. Application Data
(60) Provisional application No. 62/373,572, filed on Aug. 11, 2016.

(51) Int. Cl. A01N 25/26; A01N 59/16; A01N 59/20; C01G 5/00; C25D 11/34

(52) U.S. Cl. CPC A01N 25/26; A01N 59/16; A01N 59/20; C01P 2004/04; C25D 11/34; C01P 2002/72; C01G 5/003

(57) ABSTRACT

Methods for the production of co-deposition products include an oxidized metal species attached to silica in the presence of oxidation means. Also provided are methods for the production of composite materials which include a substrate and the co-deposition product. Furthermore, methods for producing a multi-layered co-deposition product which include two or more layers of the co-deposition product are also described. Co-deposition products comprising an oxidized species of metal, such as oxidized silver or copper, attached to silica are also provided. In a preferred embodiment, the metal is silver, and the resulting co-deposition product provides anti-microbial, anti-fungal and/or anti-biofilm properties to materials.

### CROSS REFERENCE TO RELATED APPLICATIONS

This application claims priority of U.S. Provisional Patent Application Ser. No. 62/373,572, entitled “Co-Deposition Products, Composite Materials and Processes for the Production Thereof”, filed Aug. 11, 2016, and hereby incorporated by reference herein in its entirety (where permitted).

### TECHNICAL FIELD

The present invention relates to co-deposition products, composite materials, and methods for the production of co-deposition products and composite materials.

### BACKGROUND OF THE INVENTION

Silver is known for its antimicrobial properties which are believed to be provided by silver ions. Silver ions having valent states higher than one (for example, Ag (II) and Ag (III)) may increase the overall antimicrobial properties of silver compositions, possibly because higher oxidation state silver species can have greater reduction potentials and may react over time to form other silver containing substances which may exhibit supplemental antimicrobial properties that may overcome bacterial resistance.

Consequently, it may be advantageous to produce compositions containing silver ions for use in providing antimicrobial properties. One challenge is in producing compositions which are relatively “stable,” in that the silver ions will remain in ionic form in the compositions before use so that the silver ions are available during use to provide antimicrobial properties. This is particularly difficult in environments that expose oxidized silver ions to moisture, ultraviolet light, organic molecules, or heat, which can degrade the ions over time. Another challenge is in controlling the release of silver ions from silver compositions during use. For example, some silver salts have relatively high solubility in aqueous solutions. During use, dissolving silver salts into a solution thus results in relatively quick release of silver ions into the solution, which may result in a relatively rapid deactivation of silver ions and shorten the window of time that silver salt compositions exhibit antimicrobial activity. Slowing the rate of dissolution in aqueous solutions of these soluble silver salts may prolong antimicrobial activity.

Silica (SiO₂) is a ubiquitous material. Attaching a surface layer of silica (for example, silica encapsulation) to an active core composition may provide a protective shell or surface barrier, regulating release profiles of the active core compositions, and stabilizing active core compositions (Santra et al. 2001, Kobayashi et al. 2005). In such compounds, silica may encapsulate the active core composition, and slow the degradation and decrease the solubility of the active core. However, the attachment of silica to the surface of higher oxidation state silver oxide compositions has not yet been implemented since the processes commonly employed to attach silica to the surface of active core compositions can lead to the reaction, degradation, or dissolution of higher state oxidation state silver oxides, which may result in a decrease in their antimicrobial properties.

Higher concentration silicon solutions may be generated through hydroxide condensation of SiO₂, forming stable alkaline solutions of silicate salts. In alkali silicate solutions, H₂SiO₄² and H₃SiO₄ salts are believed to be the dominant ions and stable in alkali solution. Decreasing the pH of the solution may result in the formation of H₃SiO₄ and H₄SiO₄. Silicate protonation of these salts can result in a rapid, uncontrolled formation of amorphous silica solids as expressed by the following reaction:

H₃SiO_{4 (aq)}⁻+H₄SiO_{4 (aq)}→(OH)₃Si—O—Si(OH)_{3 (s)}+OH⁻_{(aq)}

Approaches used to minimize the uncontrolled polymerization of silica in solution include reducing silica concentration, maintaining high pH, adding polymerization inhibitors, and eliminating nucleation sites.

Methods for the production of silica encapsulation on active core compositions from alkali silicate solutions are known. A layer-by-layer method, which involves alternating cationic polymers of polyethylenimine and sodium silicate solutions, has been used to coat silica on red phosphor powders of Y₂O₂S:Eu in aqueous solutions (Chung et al. 2005). Wet treatment of a titanium dioxide base pigment via controlled addition of external acid source in a silica ion solution results in a dense silica being precipitated as a coating on the titanium dioxide (U.S. Pat. No. 3,437,502 to Gwinn, Jr.). Finely divided products which are formed of particles composed of a skin of silica containing chemically combined polyvalent metal atoms and a core of another material have been prepared through slow controlled addition of external acid source in-situ with poly-valent metal and core (U.S. Pat. No. 2,913,419 to Alexander). A layered coating of titanium dioxide (TiO₂), with silica and alumina (Al₂O₃) results when the silica is applied to the pigment by precipitation from sodium silicate with controlled acid addition in an aqueous slurry of the pigment (U.S. Pat. No. 3,928,057 to DeColibus).

Lastly, chemical oxidation of silver ions (Ag⁺) may result in the formation of a solid state silver oxynitrate crystalline composition (containing both Ag(II) and Ag(III)) (Yost 1926; Djokic 2004; and Waterhouse et al. 2007). Oxidation of Ag(I) may occur by an oxidizing agent (for example, ozone or persulfate). However, methods thus far have not achieved a way to control either the nucleation of the crystalline oxidized silver compositions or the rate of crystalline growth.

Accordingly, a need exists for methods for producing oxidized silver compounds attached to silica.

### BRIEF DESCRIPTION OF DRAWINGS

Embodiments of the invention will now be described with reference to the accompanying drawings, in which:

FIG. 1 is an XRD pattern generated from an embodiment of a co-deposition product prepared in accordance with the first aspect of the invention.

FIG. 2 is an XRD pattern generated from an embodiment of a co-deposition product, different from the embodiment used in FIG. 1, prepared in accordance with the first aspect of the invention.

FIG. 3 is a TEM micrograph (magnification=20,000) generated from an embodiment of a co-deposition product prepared in accordance with the first aspect of the invention.

FIG. 4 is a set of three TEM micrographs (magnification=60,000) generated from an embodiment of a co-deposition product prepared in accordance with the first aspect of the invention.

FIG. 5 is a set of two TEM micrographs (magnification=60,000) generated from an embodiment of a co-deposition product, different from the embodiment used in FIG. 3, prepared in accordance with the first aspect of the invention.

FIG. 6 is a TEM micrograph (magnification=100,000) generated from an embodiment of a co-deposition product, different from the embodiment used in FIG. 3, prepared in accordance with the first aspect of the invention.

FIG. 7 is a TEM micrograph (magnification=40,000) generated from an embodiment of a co-deposition product, different from the embodiment used in FIG. 3, prepared in accordance with the first aspect of the invention.

FIG. 8 is a set of two TEM micrographs (magnification=60,000) generated from an embodiment of a co-deposition product, different from the embodiment used in either FIG. 3 or FIG. 4, prepared in accordance with the first aspect of the invention.

FIG. 9 is a graph of the relative number of microbes eliminated by silver oxynitrate and of an embodiment of a co-deposition product prepared in accordance with the first aspect of the invention, with log reduction plotted for both Pseudomonas aeruginosa and Staphylococcus aureus.

FIG. 10 is a graph of the relative number of microbes eliminated by silver oxynitrate, an embodiment of a co-deposition product prepared in accordance with the first aspect of the invention, silver oxynitrate formulated into an ointment, and an embodiment of a co-deposition product prepared in accordance with the first aspect of the invention formulated into an ointment, with log reduction being plotted for mature Staphylococcus aureus biofilms.

### SUMMARY OF THE INVENTION

The present invention is directed to co-deposition products, composite materials, and methods for the production of co-deposition products and composite materials. The co-deposition products comprise at least one oxidized species of a metal attached to silica. In some embodiments, the metal comprises silver, and the co-deposition products comprise oligodynamic oxidized silver species. The silica may slow the degradation and decrease the solubility of the oxidized silver species, enhancing the stability of the oxidized silver compounds and regulating the release of the silver ions from the co-deposition product into solution. Methods of the invention may enable control of nucleation and growth of oxidized metal compounds during production of co-deposition products.

In one aspect, the invention comprises a method for producing a co-deposition product comprising at least one oxidized species of a metal attached to silica, the method comprising the steps of:
(a) providing an alkali co-deposition solution comprising an amount of ions of the metal, an amount of silicate ions, and an oxidation means; and
(b) producing the co-deposition product by facilitating oxidation in the alkali co-deposition solution of the ions of the metal by the oxidation means forming the at least one oxidized species, thereby catalyzing polymerization of the silicate ions in a locus of the at least one oxidized species and forming the silica.

In one embodiment, step (a) comprises:
(i) providing an alkali oxidant-silicate solution comprising the amount of silicate ions and the oxidation means; and
(ii) adding the amount of metal ions to the alkali oxidant-silicate solution to produce the alkali co-deposition solution.

In one embodiment, step (a) comprises:
(i) providing an alkali metal-silicate solution comprising the amount of silicate ions and the amount of metal ions; and
(ii) adding the oxidation means to the alkali metal-silicate solution to produce the alkali co-deposition solution.

In another aspect, the invention comprises a method for producing a composite material comprising a substrate and a co-deposition product, wherein the co-deposition product comprises at least one oxidized species of a metal attached to silica, the method comprising the steps of:
(a) first contacting the substrate with a metal ion solution comprising an amount of ions of the metal; and
(b) second contacting the substrate with an alkali oxidant-silicate solution comprising an amount of silicate ions and an oxidation means; and
(c) producing the co-deposition product during step (b) by facilitating oxidation in the alkali oxidant-silicate solution of the ions of the metal by the oxidation means forming the at least one oxidized species, thereby catalyzing polymerization of the silicate ions in a locus of the at least one oxidized species and forming the silica, and thereby producing the composite material.

In another aspect, the invention comprises a method for producing a multi-layered co-deposition product, wherein the multi-layered co-deposition product comprises two or more layers of a co-deposition product comprising at least one oxidized species of a metal attached to silica, the method comprising the steps of:
(a) providing an alkali co-deposition solution comprising an amount of silicate ions;
(b) adding an amount of ions of the metal to the alkali co-deposition solution;
(c) adding an oxidation means to the alkali co-deposition solution; and
(d) facilitating oxidation in the alkali co-deposition solution of the ions of the metal by the oxidation means forming the at least one oxidized species, thereby catalyzing polymerization of the silicate ions in a locus of the at least one oxidized species to produce a layer; and
(e) repeating steps (b)-(d), as required, to form the multi-layered co-deposition product.

In yet another aspect, the invention comprises a co-deposition product comprising at least one oxidized species of a metal, the at least one oxidized species attached to silica.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### DETAILED DESCRIPTION

The present invention is directed at co-deposition products, composite materials, and methods for the production of co-deposition products and composite materials. The co-deposition products comprise at least one oxidized species of a metal attached to silica.

As used herein, the terms “comprises” or “comprising” should be interpreted as referring to elements, components, or steps in a non-exclusive manner, indicating that the referenced elements, components, or steps may be present, or utilized, or combined with other elements, components, or steps that are not expressly referenced.

As used herein and in the appended claims, the singular forms “a,” “an,” and “the” include plural referents unless the context clearly dictates otherwise.

As used herein, the term “deposition” means any process by which substances can settle out of a solution or suspension to form a solid-state material. In some instances, “deposition” may include precipitation of a solid-state material out of solution.

As used herein, the term “co-deposition” means the simultaneous deposition of two or more substances.

As used herein, the term “co-deposition product” means any solid-state material comprised of two or more substances. In some instances, a “co-deposition product” may be formed by co-deposition.

As used herein, the terms “oxidized species of a metal” and “oxidized metal species” mean a chemical species of a metal that has undergone the process of oxidation, thereby increasing the valence state of the metal. More particularly, the “oxidized species of a metal” or “oxidized metal species” may comprise ions of the metal having valent states of one and higher, which may include, but are not limited to, (I), (II), (III) and (IV) oxidation states and mixtures thereof. The “oxidized species of a metal” and “oxidized species of a metal” may also include metal oxides.

As used herein, the term “oxidized silver species” may include, but is not limited to, all compounds of silver where the silver is in Ag(I), Ag(II), and Ag(III) valent states or any combinations thereof. These oxidized species may include, for example, silver (I) oxide, silver (II) oxide, silver (III) oxide, or mixtures thereof, all silver salts having a solubility product higher than 10⁻²⁰ (such as for example Ag₂SO₄, AgCl, Ag₂S₂O₈, Ag₂SO₃, Ag₂S₂O₃, Ag₃PO₄, and the like), and Ag₇O₈X, where X may include, but is not limited to, HCO₃⁻, CO₃², NO₃⁻, ClO₄⁻, SO₄⁻, F⁻, and mixtures thereof.

As used herein, the terms “attached” or “attachment” mean that at least a portion of the surface of the oxidized species of a metal may be attached to silica. In some instances, “attached” and/or “attachment” may include an ionic bond between the surface of the oxidized species of a metal and silica. In some instances, “attached” and/or “attachment” may include electrostatic and/or van der Waals forces between the oxidized species of a metal and silica. More particularly, it is not intended that the terms “attached” and “attachment” be limited to any range of relative amounts of silica that is attached to the surface of the oxidized species of a metal. The terms “attached” and “attachment” may include a particle of silica “attached” to the oxidized species of the metal, but may also include a silica layer that partly or fully covers the surface of oxidized species of the metal (e.g., silica encapsulation). Further, “attached” and “attachment” may also include a relatively thick, three-dimensional silica matrix (e.g., a framework), which may be used to support particles of the oxidized species of the metal.

As used herein, the term “substrate” means any substance or material. In some instances, a “substrate” may be a substance or material upon which a co-deposition product may be deposited. In some instances, a “substrate” may include a substance or material that has at least one surface upon which a co-deposition product can be deposited. In some instances, a “substrate” may include an interface between two substances or materials, such as for example, gas-liquid, liquid-liquid, solid-liquid, or solid-solid interfaces, upon which a co-deposition product can be deposited. Without limitation, the substrate may comprise, for example, metal, plastic, paper, glass, ceramic, textile, rubber, polymer, composite material, or any combination of substrates.

As used herein, the term “composite material” means any material comprising two or more constituent substances. In some instances, “composite material” may include a layer of a co-deposition product deposited on a substrate. The thickness of the co-deposition layer may vary. However, the thickness of the layer may range from about a fraction of a nanolayer (i.e., a monolayer of atoms) to about several micrometers. As a non-limiting example, the co-deposition product layer may be deposited by a chemical means, whereby a fluid precursor undergoes a chemical change at the surface, resulting in deposition of the co-deposition and formation of a layer on the surface. As another non-limiting example, the layer may be deposited by a physical means, where a mechanical, electromechanical, or thermodynamic means is used to apply a thin layer of a co-deposition product on a substrate.

As used herein, the term “oligodynamic” means the relative toxicity of certain substances on cells, algae, molds, spores, fungi, viruses, and prokaryotic and eukaryotic microorganisms, even in relatively low concentrations.

As used herein, the term an “oligodynamic metal” means any metal whose ions are believed to be oligodynamic. An “oligodynamic metal” may, for example, exhibit antimicrobial, anti-fungal, and anti-biofilm properties and may include, but is not limited to, aluminum, barium, boron, copper, gold, lead, mercury, nickel, thallium, tin, zinc, silver, and combinations thereof.

As used herein, the term “functional group” means an atom or group of atoms present in a compound or substance that may affect the chemical behavior of the compound or substance. In other words, a “functional group” present in a compound or substance may fully or partly define what other molecules with which the compound or substance will react.

As used herein, the term “functionalization” means any process by which a functional group may be added to a compound or substance.

As used herein, the term “functionalization reagent” means any reagents used for the functionalization that initially contains the functional group, and subsequently donates the functional group to the compound or substance during functionalization.

As used herein, the term “strong alkali compound” means any compound that may form a pH in aqueous solutions ranging from about 10 to about 14.

As used herein, the term “alkali effecting ion” means any ion that may be a strong alkali compound.

As used herein, the term “reaction zone” means the portion of a solution that has a pH of less than about 9.84.

As used herein, the term “localized pH” means the pH of the solution within the reaction zone.

As used herein, the term “overall pH” means the pH of the solution that is outside the reaction zone. In some instances, the “overall pH” may be a pH of at least about 9.84.

As used herein, the term “total silver” means the total amount of silver which may include elemental (metallic) silver as well as silver originating from oxidized silver species, as determined by a chemical analysis.

In some embodiments, the methods of the present invention may produce a co-deposition product comprising at least one oxidized species of a metal attached to silica. These methods may also be used to control the size and distribution of oxidized species of a metal attached to silica.

In some embodiments, the silica may enhance the stability of the oxidized species of the metal, control the release of the metal ions, and facilitate surface functionalization. In some embodiments, the methods of the invention may be used to regulate nucleation and growth of the oxidized species of the metal.

In some embodiments, the metal may be selected so that it is compatible with the production of the desired co-deposition product. Any suitable metal may be used. The metal may also comprise more than one element, with the result that the co-deposition product may comprise at least one oxidized species of more than one metal element.

In some embodiments, the metal may comprise an oligodynamic metal. In some embodiments, the oligodynamic metal may comprise silver. More particularly, it is believed that attachment of silica may slow the degradation and decrease the solubility of the oxidized silver species, thereby enhancing the stability of the oxidized silver compounds and regulating the release of the metal ions from the co-deposition product into solution. For example, the silica attachment may delay the release of oxidized silver ions via the relatively slow dissolution of silica in aqueous solutions.

In some embodiments, selecting an oligodynamic metal may result in a co-deposition product that may exhibit anti-microbial, anti-fungal, and anti-biofilm properties. In some embodiments, the metal may comprise a combination of metals. The presence of other metals in the co-deposition product, in addition to an oligodynamic metal, may enhance the anti-microbial, anti-fungal, anti-biofilm properties and/or provide other complementary properties. In some embodiments, other metals present in the co-deposition product may exhibit complementary catalytic properties, such as for example, base-catalyzed oxidation resulting in the degradation of polysaccharides and metal catalyzed Fenton-like reactions may occur via reactive oxygen species, which can oxidize organic compounds including carbohydrates, amino acids, DNA, etc.

In some embodiments, the oligodynamic metal may be copper. In some embodiments, the metal may be silver.

The methods of the present invention are based upon chemical and/or electrochemical deposition principles and techniques, and silica polymerization principles and techniques. Specifically, it is believed that silicate ions will polymerize to form silica in solutions having a pH of less than about 10 (H₄SiO₄, PKₐ₁=9.84).

In some embodiments, the metal may be selected so that oxidation of the metal ion in a solution having an overall pH of at least about 9.84 may result in the production of hydronium ions (or the depletion of hydroxide ions), which may, in some embodiments, result in a decrease in the localized pH at the location or vicinity of the oxidized metal ion and the creation of a reaction zone.

More particularly, the methods may be reliant upon localized gradients of pH formed by the oxidation of a metal ions, which may result in the protonation and polymerization of silica in the location of the newly oxidized metal.

In certain aspects, methods are provided for the production of a co-deposition product comprising at least one oxidized species of a metal that is attached to silica. The co-deposition product may comprise oxidized metal compounds. In particular, the methods of the invention may be used to produce co-deposition products with enhanced stability relative to the oxidized metal compounds alone. It is believed that co-deposition products produced using the methods of the invention may possibly confer altered surface properties of the oxidized metals.

Without being bound by any theory, it is believed in embodiments where the metal is silver, the oligodynamic properties may be due to the presence in the co-deposition product of one or more oxidized silver species, including silver ions having valent states higher than one, such as for example Ag(II) and Ag(III).

In some embodiments, the methods of the invention may also result in the formation of co-deposition products comprising silver oxides: AgO, Ag₂O, Ag₂O₂, Ag₂O₃, and Ag₇O₈X, where X is an anion. The co-deposition product may comprise Ag₂SO₄. The anion X may comprise a single anion or a plurality of different anions. The anions may therefore comprise any anion or combination of anions. The anion may, for example, be selected from the group of anions consisting of HCO₃⁻, CO₃²⁻, NO₃⁻, ClO₄⁻, SO₄⁻, F⁻, and mixtures thereof.

In certain aspects, the methods of the invention are particularly suited for producing a composite material comprising a substrate and one or more layers of the co-deposition product. The coating may be deposited so that it does not completely cover the substrate, thus leaving portions of the surface of the substrate uncovered.

The methods of the invention may be adapted to control the oxidized species, the metal/silica ratio and physical dimensions of the co-deposition products, facilitating the production of a variety of co-deposition products having variable stoichiometry and geometry. More particularly, in some embodiments, the methods of the invention produce co-deposition products comprising nanoparticles (i.e., physically sized on the nano-scale regime).

In a first aspect, the invention is a method for producing a co-deposition product comprising at least one oxidized species of a metal attached to silica, the method comprising the steps of:
(a) providing an alkali co-deposition solution comprising an amount of ions of the metal, an amount of silicate ions, and an oxidation means; and
(b) producing the co-deposition product by facilitating oxidation in the alkali co-deposition solution of the ions of the metal by the oxidation means forming the at least one oxidized species, thereby catalyzing polymerization of the silicate ions in a locus of the at least one oxidized species and forming the silica.

In some embodiments, step (a) of providing the alkali co-deposition solution may comprise:
(i) providing an alkali oxidant-silicate solution comprising the amount of silicate ions and the oxidation means; and
(ii) adding the amount of metal ions to the alkali oxidant-silicate solution to produce the alkali co-deposition solution.

In some embodiments, the metal ions may be added to the alkali oxidant-silicate solution (in step (a)(ii) above) by adding a metal ion solution comprising the metal ions to the alkali oxidant-silicate solution. The pH of the metal ion solution can be any pH. However, in some embodiments, the pH of the metal ion solution may be selected so that adding the metal ion solution to the alkali oxidant-silicate solution does not substantially change the overall pH of the alkali oxidant-silicate solution. Further, in some embodiments, the pH of the metal ion solution may be selected so that the metal ions are stable in the metal ion solution. In some embodiments, the pH of the metal ion solution may have a pH ranging from about 5 to about 9.

In some embodiments, the amount of metal ions added to the alkali oxidant-silicate solution (in step (a)(ii) above) may be selected to be less than, or equal to, the amount of metal ions that can be oxidized by the oxidizing means contained in the alkali oxidant-silicate solution.

In some embodiments, the amount of metal ions added to the alkali oxidant-silicate solution (in step (a)(ii) above) may be selected so that oxidation of the metal ions does not substantially change the overall pH of the alkali co-deposition solution produced.

The addition of the metal ions to the alkali oxidant-silicate solution (in step (a)(ii) above) may be performed over a range of rates. In some embodiments, the addition may be performed between about 2 minutes to about 60 minutes. In some embodiments, the addition may be performed between about 30 seconds to about 5 minutes. In some embodiments, the rate of addition of the metal ions to the alkali oxidant-silicate solution may be in the rate of about 0.002 moles/minute to about 0.9 moles/minute.

In some embodiments, the rate of addition of the metal ions to the alkali oxidant-silicate solution (in step (a)(ii) above) may be decreased in order to slow the nucleation and growth of the at least one oxidized species of the metal. Accordingly, it is believed that the methods according to the first aspect may allow for the control of the nucleation and growth of the oxidized species of the metal.

Alternatively, in some embodiments, step (a) of providing the alkali co-deposition solution may comprise:
(i) providing an alkali metal-silicate solution comprising the amount of silicate ions and the amount of metal ions; and
(ii) adding the oxidation means to the alkali metal-silicate solution to produce the alkali co-deposition solution.

In some embodiments, the oxidation means may be added to the alkali metal-silicate solution (in step (a)(ii) above) by adding an oxidation solution comprising the oxidation means to the alkali metal-silicate solution. The pH of the oxidation solution can be any pH. However, in some embodiments, the pH of the oxidation solution may be selected so that adding the metal ion solution to the alkali metal-silicate solution does not substantially change the overall pH of the alkali metal-silicate solution. In some embodiments, the pH of the oxidation solution may have a pH ranging from about 5 to about 9.

In some embodiments, the amount of oxidation means added (in step (a)(ii) above) to the alkali metal-silicate solution may be selected to not exceed the amount required to oxidize substantially all of the metal ions in the alkali metal-silicate solution.

In methods of the invention according to the first aspect, the metal may comprise any metal or combination of metals, and the metal ions may comprise any metal ions or combination of metal ions. The alkali co-deposition solution may comprise metal ions from any source or in any form. In some embodiments, the alkali co-deposition solution may comprise a metal ion compound containing the metal ions, comprising a soluble inorganic salt, a chelated compound, a suspension, or fine dispersion. In some embodiments, the amount of metal ion compound added to the alkali co-deposition solution may be selected so that the concentration of the metal ion compound is between about 1 gram per litre to about 60 grams per litre.

In some embodiments, the metal may be further selected so that oxidation of the metal ion in the alkali co-deposition solution results in the production of hydronium ions (or the depletion of hydroxide ions), which may lead to a decrease in the localized pH in the vicinity of the oxidized metal ion and the creation of a reaction zone.

More particularly, within the alkali co-deposition solution, prior to oxidation, metal ions may be present as an aqueous species or stable solid phase. In some embodiments, the overall pH of the alkali-silicate solution may be sufficiently high to keep the silicate ions in solution. Without being bound by any theory, oxidation of the metal ions may result in the formation of acid by-products (or the depletion of hydroxide ions) in the location or vicinity of the oxidized metal ion, resulting in a decrease in the localized pH in the location of the newly oxidized metal compounds. This decrease in the localized pH may result in the creation of a reaction zone and the formation of silica polymers on the surface of the oxidized metal and attachment of the oxidized metal to silica. In other words, it is believed that the methods of the invention may couple the precipitation of alkali silicate in situ with the oxidation and precipitation of a metal. Presence of salts and generation of divalent metal states may further assist in the polymerization of the silica, forming a three-dimensional network of oxidized metal species attached within a silica layer. For example, divalent metal ions may assist in polymerization via the creation of nucleation and growth sites for the silica polymerization. Insolubility of silicate metal salts may create nucleation sites, from which silicate polymerization may propagate.

In some embodiments, the metal may comprise an oligodynamic metal and the co-deposition product produced by the methods according to the first aspect may have specific anti-microbial, anti-biofilm, and anti-fouling properties. Co-deposition products may be useful, for example, as components for electronics, food and agriculture products, medical devices, drugs, drug carriers, and cosmeceuticals.

In some embodiments, the metal may comprise silver and the ions of the metal may comprise silver ions. In some embodiments that use silver, the alkali co-deposition solution may comprise silver ions from any source or in any form. The source of silver ions may include silver compounds such as metallic silver, silver nitrate, silver sulfate, silver chloride, silver oxide, diamino silver complexes such as diammonium silver, triethylenetetramine silver, dimonoethanolamine silver, or carboxyl complexes, such as silver acetate, silver citrate, silver oxalate, or combinations thereof.

In some embodiments, the alkali co-deposition solution may comprise a silver salt. In some embodiments, the silver salt may comprise silver nitrate. In some embodiment, the alkali co-deposition solution may be provided by adding a metal ion solution to an alkali oxidant-silicate solution. In some embodiments, the metal ion solution may comprise a silver nitrate solution having a concentration of silver nitrate in the range of about 0.01 M to about 0.46 M. In some embodiments, the silver nitrate solution may be added to the alkali oxidant-silicate solution at a rate of 0.002 moles/minute to 0.9 moles/minute.

In some embodiments, the overall pH of the alkali co-deposition solution may be sufficiently high to maintain silicate ion monomers in solution. Therefore, the alkaline co-deposition solution may comprise an amount of any strong alkali compound forming an overall pH that keeps silicate ions in solution. In some embodiments, the alkaline co-deposition solution is comprised of alkali effecting ions, which may provide a relatively strong alkaline environment having an overall pH of at least about 10.

In some embodiments, the alkali effecting ion may comprise one or more alkali metals, such as for example sodium, potassium, lithium, rubidium, cesium, francium, or a mixture thereof. As a non-limiting example, the alkali effecting ion may be provided in the alkali co-deposition solution by dissolving a silica salt of an alkali metal (referred to hereinafter as an “alkali metal-silica salt”) in an aqueous solution, thereby providing both the alkali effecting ion and the silicate ions. In some embodiments, the alkaline co-deposition solution may have a concentration of alkali metal-silicate salt ranging between about 0.001 M and about 1.5 M. In some embodiments, the alkaline co-deposition solution may have a concentration of alkali metal-silicate salt ranging between about 0.01 M and about 0.1 M. In some embodiments, the alkali metal-silica salt may comprise potassium silicate having a concentration in the alkali co-deposition solution in the range of 0.01 M to 0.18 M.

In some embodiments, the alkali effecting ion is present in a stoichiometrically excess amount to create a buffering capacity of the alkali co-deposition solution. In some embodiments, the buffering capacity of the alkaline co-deposition solution may allow for oxidation of the metal ions without a substantial change in overall pH of the solution. In some embodiments, the alkaline co-deposition solution may have an overall pH between about 10 to about 14. In some embodiments, the alkaline co-deposition solution may have an overall pH between about 10 to about 12 and a concentration of excess or buffering hydroxide concentration between about 0.0001 M to about 0.01 M.

In some embodiments, anions may be present in the alkali co-deposition solution during the co-deposition product producing step. The metal compound, which is used to provide the ions of the metal, may comprise the anion. For example, where the alkali co-deposition solution comprises silver salt, such as silver nitrate, the anion may comprise the nitrate ion (NO₃⁻). In some embodiments, the alkali metal-silica salt may be the source of the anion. In some embodiments, an alternate ternary source of anions may be added to the alkali co-deposition solution. Where the alternate ternary source of the anion is used, the stoichiometric ratios of the anion added may be adjusted according to the production of the desired co-deposition product and the anions may consist of organic or inorganic acids. Accordingly, the methods of the invention may result in the formation of oxidized silver compounds including, without limitation, silver sulfate, silver chloride, silver nitrate, silver carbonate, silver sulfate, silver silicate, or combinations thereof.

In some embodiments, the means for oxidizing the metal may be selected to be compatible with the production of the co-deposition product. As a result, any suitable oxidation means that has a sufficient oxidation potential to produce the desired co-deposition product may be used in the invention.

In some embodiments, the oxidizing means may comprise a chemical oxidizing agent. In some embodiments, the oxidizing agent may comprise any chemical oxidant that is compatible with the metal and of sufficient oxidation potential to effect a change in the valence state of the selected metal. In some embodiments, the oxidizing agent may be selected from persulfates, permanganates, periodates, perchlorates peroxides, ozone, or mixtures thereof. In some embodiments, the oxidizing agent may be selected from persulfate or ozone. Oxidation of silver ions by persulfate may result in a rapid color transition from a clear, colorless to solution, through transparent yellow/brown color (previously attributed to the formation of silver (II) nitrate complexes (Djokic 2004; Honig & Kustin 1970)), to the formation of a grey/black precipitate of silver oxynitrate. By-products of this reaction include sulfuric and nitric acid:

7AgNO_{3 (aq)}+K₂S₂O_{8 (aq)}+8H₂O₍ₗ₎→Ag₇O₈NO_{3 (s)}+6HNO_{3 (aq)}+H₂SO_{4 (aq)}+K₂SO_{4 (aq)}+4H_{2 (g)}

The persulfate may comprise any persulfate, but may be a persulfate salt of sodium, potassium, ammonium, or mixtures thereof. In some embodiments, the persulfate may comprise potassium persulfate having a concentration in the range of about 0.01 M to about 0.17 M. In some embodiments, the concentration may be above about 0.05 M. In some embodiments, the concentration may be about 0.16 M.

In some embodiments that use ozone as the oxidizing agent, the ozone may be fed into the alkali co-deposition solution through saturation of the solution or continuous feed throughout the course of the reaction:

7Ag⁺_{(aq)}+NO_{3 (aq)}⁻+5O_{3 (g)}→Ag₇O₈NO_{3 (s)}+5O_{2 (g)}+6H⁺_{(aq)}

The amount of the oxidizing agent may be selected to be compatible with the amount of the metal ions in the alkali co-deposition solution so that the co-deposition product may be produced as efficiently as possible. In other words, the amount of the oxidizing agent may be selected to be a stoichiometrically appropriate amount relative to the amount of ions of the metal present. In embodiments that use persulfate as the oxidizing agent, the amount of persulfate may be selected so that the concentration of the persulfate in the alkali co-deposition solution is between about 1 gram per liter and about 45 grams per liter.

In some embodiments, the oxidation means may comprise an electrochemical oxidation assembly which polarizes a working electrode. In some embodiments, the working electrode may be polarized to a potential (E) in the range of 0.6 to 2.1 vs. standard hydrogen electrode (SHE), which affords anodic polarization of a working electrode resulting in the formation of oxidized metals, preferably argentic oxysalts, deposited from a silver nitrate solution:

17Ag⁺+NO_{3 (aq)hu -}+8H₂O₍ₗ₎→Ag₇O₈NO_{3 (s)}+10Ag+16H⁺_{(aq)}

In some embodiments, the working electrode may be polarized to a potential (E) in the range of 1.74 to 1.77 vs. SHE.

In some embodiments, the co-deposition product producing step may be performed for any length of time which is sufficient to produce a desired yield of co-deposition product of the desired composition. In some embodiments, the co-deposition product producing step may be performed for at least about 5 minutes to about 2 hours. In some embodiments, the co-deposition product producing step (b) may be performed for between about 30 minutes and about 90 minutes.

In some embodiments, the methods of the invention may further comprise agitating the alkali co-deposition solution during at least a portion of the co-deposition product producing step. In some embodiments, the alkaline co-deposition solution may be agitated throughout the co-deposition product producing step. In some embodiments, agitation may occur through an impeller, rotary stirring tool, or high shear mixing implement.

In some embodiments, the alkali co-deposition solution may further comprise a stabilizing agent to stabilize the co-deposition product and to limit co-deposition product growth beyond a certain desired dimension, such as for example nanostructures. In some embodiments, the stabilizing agents may include, but are not limited to, surfactants, emulsifiers, gelling agents, thickening agents, polymeric stabilizers (e.g., polymeric peptides, biguanides, polybiguanides, imine-functionalized chelates, polyvinylpyrrolidone, polyethylene oxide and polyethylene oxide copolymers, natural gums, acetylated glycerides, polysaccharide based polymers and surfactants, polyols, protein-based polymers, and silicon-based polymers), Pickering agents, and combinations thereof.

As mentioned above, the methods according to the first aspect may allow for control of nucleation and growth of oxidized metal compounds during the co-deposition product producing step. For example, it is believed that either decreasing the amount of ions of the metal, or increasing the amount of silicate ions, in the alkali co-deposition solution may control the number of nucleation sites and the growth of metal oxides during co-deposition product producing step. In other words, by varying the ratio of metal ions to silicate ions in the alkali co-deposition solution, control over the growth and resulting physical dimensions of the oxidized metal species may be achieved.

In some embodiments, the co-deposition product producing step may be performed at relatively low temperature, since co-deposition product may experience increasing solubility with increasing temperature. In some embodiments, the co-deposition product producing step may be performed at a temperature less than about 95 degrees Celsius. In some embodiments, the co-deposition product producing step may be performed at a temperature between about 1 degree Celsius and about 85 degrees Celsius. In some embodiments, the co-deposition product producing step may be performed at a temperature between about 15 degrees Celsius and about 25 degrees Celsius.

In some embodiments, the alkali co-deposition solution may be agitated during at least a portion of the co-deposition product producing step in order to homogenize the production of the co-deposition product.

The methods according to the first aspect may also include following the co-deposition product producing step with the step of isolating the co-deposition product. The technique for isolating the co-deposition product may be selected so that minimal degradation of the co-deposition product occurs during isolation, which may include, for example, filtration, phase extraction, centrifugation, lyophilization, spray drying, or any combination thereof.

The methods according to the first aspect may also include following the isolation of the co-deposition product step with the step of re-suspending the produced co-deposition product in an aqueous or non-aqueous solvent to deposit the co-deposition product on a substrate. In some embodiments, the solvent may a non-protic solvent maintained at temperatures less than about 25 degrees Celsius. In some embodiments, the non-protic solvent may be maintained at temperatures less than about 5 degrees Celsius. Re-suspension of the co-deposition product into the solvent may occur via re-suspension techniques including sonication, mixing, milling, vortexing, shearing, or a combination thereof. In some embodiments, the solvent may further comprise additives to control the rheology of the solvent, including, but not limited to, thickening agents, gelling agents, viscosity modifiers, rheology modifiers, fillers, dyes, and a combination thereof. In some embodiments, the means for depositing the co-deposition product/solvent on the substrate may consist of air-knife blowing, rotogravure printing, dipping, rolling, screening, slot-die coating, spraying, spinning, printing, or a combination thereof.

The method according to the first aspect may also include following the isolation of the co-deposition product step with the step of formulating the isolated co-deposition product into an aqueous, non-aqueous, or dry powder formulation. The formulations may comprise, for example, oils, surfactants, emulsifiers, thickeners, gelling agents, fillers, excipients, other active ingredients, or a combination thereof. In some embodiments, the co-deposition product may be formulated into an aqueous or oiled-based formulation such that the amount of total silver in the formulation is selected to be between about 0.1 and about 50 weight percent silver. In some embodiments, the amount of total silver in the formulation is selected to be between about 0.1 and about 2.0 weight percent silver, which may provide effective anti-microbial and anti-biofilm properties.

The methods according to the first aspect may also include following the isolation of the co-deposition product step with the step of formulating the co-deposition product into a thermoplastic polymer or curable polymer. Incorporation of the co-deposition product into the polymer product may occur through any technique of agitation including, for example, mixing, vortexing, sonication, shearing, milling, or a combination thereof. In some embodiments, the thermoplastic polymer may have a melt transition temperature of less than about 105 degrees Celsius. In some embodiments, the melt transition temperature may be less than about 60 degrees Celsius. In some embodiments, the co-deposition product may be formulated into a curable polymer that may be cured via UV light, heat, addition of a catalyst, addition of radical initiators, drying, or a combination thereof. Following formulation, the polymer may be deposited, coated, formed, or molded into structures or devices such as, but not limited to, wound dressings, splints, sutures, catheters, implants, tracheal tubes, orthopedic devices, ophthalmic devices, prosthetic devices, medical instruments, laboratory, clinic and hospital equipment, furniture and furnishings, dental devices, and health care and consumer products.

The methods according to the first aspect may also include the step of functionalizing the silica of the co-deposition product by adding chemical functional groups to the silica. In some embodiments, the chemical functional groups may comprise, for example, alkoxysilanes, halosilanes, or a combination thereof. Functionalizing reagents used in adding the functional groups to the silica may comprise, for example, 3-aminopropyl triethoxysilane, 3-mercaptopropyl trimethoxysilane, PEG-silanes, or a combination thereof.

The methods according to the first aspect may include following the functional group addition step with the step of anchoring the co-deposition product to a substrate by facilitating a chemical reaction between the functional groups and the substrate. The substrate may comprise, for example, metal, glass, and ceramic materials. The methods of the invention may also anchor the co-deposition product to biological targets, which may comprise, for example, monoclonal antibodies, doxorubicin, or proteins.

In a second aspect, the invention is a method for producing a composite material comprising a substrate and a co-deposition product, wherein the co-deposition product comprises at least one oxidized species of a metal attached to silica, the method comprising the steps of:
(a) first contacting the substrate with a metal ion solution comprising an amount of ions of the metal;
(b) second contacting the substrate with an alkali oxidant-silicate solution comprising an amount of silicate ions and an oxidation means; and
(c) producing the co-deposition product by facilitating oxidation in the alkali oxidant-silicate solution of the ions of the metal by the oxidation means forming the at least one oxidized species, thereby catalyzing polymerization of the silicate ions in a locus of the at least one oxidized species and forming silica, and thereby producing the composite material.

The pH of the metal ion solution may be any pH. In some embodiments, the pH of the metal ion solution may be selected so that the metal ion is stable in the metal ion solution. In some embodiments, the pH of the metal ion solution may have a pH in the range of about 5 to about 9.

The methods according to the second aspect may include following the co-deposition product production step with the step of removing unfixed material from the substrate. In some embodiments, the removing of unfixed material includes a rinsing or agitation step. Techniques for the removing of unfixed material may include, for example, washing with solvent, mechanical brushing with brushes, air-blade blowing, electrostatic capture of unfixed material, or a combination thereof.

The methods according to the second aspect may be further include the step, prior to the first contacting step, of etching the substrate. The techniques of etching may include, for example, chemical or physical techniques of abrasion effecting an increased roughness of the surface, increasing the surface area for adhesion, and co-deposition of the co-deposition product on the substrate. More particularly, techniques of etching may, for example, include alkali, solvent, acid, corona plasma, flame, UV, mechanical abrasion, or a combination thereof.

In some embodiments, the methods according to the second aspect may further comprise patterned depositing of the co-deposition product onto the substrate in a controlled fashion in a pre-determined desired pattern. In some embodiments, the metal ion solution may be applied to the substrate during the first contacting step via a patterned coating technique such as air-knife blowing, rotogravure printing, screening, slot-die coating, spraying, spinning, printing, or a combination thereof. In some embodiments, the metal ions may be differentially adsorbed or absorbed on the surface of the substrate during the first contacting step. The adsorption or absorption of the metal ions may also be facilitated by a previously patterned substrate wherein different physiochemical properties of the substrate may afford greater or selective adsorption or absorption of metal ions without controlled depositing of metal ion solution. In some embodiments, such physiochemical properties may include physical deformations or differential adsorption or absorption properties. Accordingly, composite materials formed in some embodiments may have spatial arrangement of the co-deposition products on the substrate.

The metal may comprise any metal or combinations of metals and the metal ions may comprise any metal ions or combination of metal ions. The metal ion solution may comprise metal ions from any source or in any form, but, in some embodiments, the metal ion solution may comprise a metal ion compound comprising a soluble inorganic salt, a chelated compound, a suspension, or fine dispersion added to the metal ion solution. In some embodiments, the amount of metal ion compound in the metal ion solution may be selected so that the concentration of the metal ion compound is between about 1 gram per litre to about 250 grams per litre.

In some embodiments, the metal may comprise an oligodynamic metal and the co-deposition product produced by the methods according to the second aspect may have specific anti-microbial, anti-biofilm, and anti-fouling properties. Co-deposition products may be useful, for example, as components for electronics, food and agriculture products, medical devices, drugs, drug carriers, and cosmeceuticals.

In some embodiments, the composite material may be useful, for example, in maintaining interfacial properties of adhesive medical devices, hydrophobicity and smoothness of implantable devices, hydrophobicity of hydrogeling or absorbent wound dressings, or loading the co-deposition product onto an inert or excipient towards formulation into drug or device constructs.

In some embodiments, the metal may comprise silver and the ions of the metal are comprised of silver ions. In embodiments that use silver, the metal ion solution may comprise silver ions from any source or in any form but, in some embodiments, the metal ion solution may comprise a silver salt. In some embodiments, the silver salt may comprise silver nitrate.

In some embodiments, the metal may be further selected so that oxidation of the metal ion in the alkali co-deposition solution results in the production of hydronium ions (or the depletion of hydroxide ions), which may lead to a decrease in the localized pH in the vicinity of the oxidized metal ion and the creation of a reaction zone.

More particularly, within the alkali co-deposition solution, prior to oxidation, metal ions may be present as an aqueous species or stable solid phase. As mentioned above, the overall pH of the alkali-silicate solution may, in some embodiments, be sufficiently high to keep the silicate ions in solution. Without being bound by any theory, oxidation of the metal ions may result in the formation of acid by-products (or the depletion of hydroxide ions) in the location or vicinity of the oxidized metal ion, resulting in a decrease in the localized pH in the location of the newly oxidized metal compounds. This decrease in the localized pH may result in the creation of a reaction zone and the formation of silica polymers on the surface of the oxidized metal and attachment of the oxidized metal to silica. In other words, it is believed that the methods of the invention may couple the condensation of alkali silicate in situ with the oxidation of a metal. Generation of divalent metal states may further assist in the polymerization of the silica, forming a three-dimensional network of oxidized metal species attached within a silica layer. For example, divalent metal ions may assist in polymerization via the creation of nucleation and growth sites for the silica polymerization. Insolubility of silicate metal salts may create nucleation sites, from which silicate polymerization may propagate.

According to methods according to the second aspect, the alkali oxidant-silicate solution may have an overall pH sufficiently high to maintain silicate ion monomers in solution. Therefore, the alkali oxidant-silicate solution may comprise an amount of any strong alkali compound forming a pH that keeps silicate ions in solution. In some embodiments, the alkali oxidant-silicate solution comprises alkaline effecting ions, which may provide a relatively strong alkaline environment having an overall pH of at least about 10.

The alkali effecting ion may comprise one or more alkali metals, such as for example sodium, potassium, lithium, rubidium, cesium, francium, or a combination thereof. As a non-limiting example, the alkaline effecting ion may be provided in the alkali oxidant-silicate solution by dissolving an alkali metal-silica salt in an aqueous solution, thereby providing both the alkali effecting ion and the silicate ions. In some embodiments, the alkali oxidant-silicate solution may have a concentration of alkali metal-silicate salt within the range of about 0.001 M to about 1.5 M. In some embodiments, the alkali oxidant-silicate solution may have a concentration of alkali metal-silicate salt within the range of about 0.01 M to about 0.1 M.

In some embodiments, the alkali effecting ion may be present in a stoichiometrically excess amount to create a buffering capacity of the alkali oxidant-silicate solution. In some embodiments, the buffering capacity of the alkali oxidant-silicate solution may allow for oxidation of the metal ions without a substantial change in overall pH of the solution. In some embodiments, the alkaline co-deposition solution may have an overall pH between about 10 to about 14. In some embodiments, the alkali oxidant-silicate solution may have an overall pH between about 10 and about 12 and a concentration of excess or buffering hydroxide concentration between about 0.0001 M and about 0.01 M.

In some embodiments, anions may be present in the alkali oxidant-silicate solution during the co-deposition product producing step. In some embodiments, an alternate ternary source of anions may be added to the alkali co-deposition solution. Where the alternate ternary source of the anion is used, the stoichiometric ratios of the anion added may be adjusted according to the production of the desired co-deposition product and the anions may consist of organic or inorganic acids. Accordingly, the methods of the invention may result in the formation of oxidized silver compounds including, without limitation, silver sulfate, silver chloride, silver nitrate, silver carbonate, silver sulfate, silver silicate, or a combination thereof.

The means for oxidizing the metal may be selected to be compatible with the production of the co-deposition product. As a result, any suitable oxidation means that has a sufficient oxidation potential to produce the desired co-deposition product may be used in the methods of the second aspect.

In some embodiments, the oxidizing means may comprise a chemical oxidizing agent. The oxidizing agent may comprise any chemical oxidant that is compatible with the metal and of sufficient oxidation potential to effect a change in the valence state of the selected metal. In some embodiments, the oxidizing agent may be selected from persulfates, permanganates, periodates, perchlorates peroxides, ozone, or mixtures thereof. In some embodiments, the oxidizing agent may be selected from persulfate and ozone. The persulfate may comprise any persulfate, but may be a persulfate salt of sodium, potassium, ammonium, or mixtures thereof. In some embodiments, the persulfate may comprise the potassium salt. In embodiments that use ozone as the oxidizing agent, the ozone may be fed into the alkali oxidant-silicate solution through saturation of the solution or continuous feed throughout the course of the reaction.

The amount of the oxidizing agent may be selected to be compatible with the amount of the metal ions in the alkali oxidant-silicate solution so that the co-deposition product may be produced as efficiently as possible. In other words, the amount of the oxidizing agent may be selected to be a stoichiometrically appropriate amount relative to the amount of ions of the metal. In embodiments that use persulfate as the oxidizing agent, the amount of persulfate may be selected so that a concentration of the persulfate in the alkali oxidant-silicate solution is between about 1 gram per liter and about 45 grams per liter.

In some embodiments, the oxidation means may comprise an electrochemical oxidation assembly, which polarize a working electrode. In some embodiments, the working electrode may be polarized to a potential (E) in the range of 0.6 to 2.1 vs. standard hydrogen electrode (SHE). In some embodiments, the working electrode may be polarized to a potential (E) in the range of 1.74 to 1.77 vs. SHE.

The co-deposition product producing step may be performed for any length of time which is sufficient to produce a desired yield of co-deposition product of the desired composition. In some embodiments, the co-deposition product producing step may be performed for at least about 5 minutes to about 2 hours. In some embodiments, the co-deposition product producing step may be performed for between about 30 minutes and about 90 minutes.

According to the second aspect of the invention, the methods may further comprise agitating the alkali oxidant-silicate solution during at least a portion of the co-deposition product producing step in order to homogenize the production of the co-deposition product. In some embodiments, the alkali oxidant-silicate solution may be agitated throughout the co-deposition product producing step. In some embodiments, this agitation may occur through an impeller, rotary stirring tool, sonication, or high shear mixing implement.

In some embodiments, the alkali oxidant-silicate solution may further comprise a stabilizing agent that is believed to stabilize the co-deposition product. Further, the stabilizing agent may limit co-deposition product growth beyond a certain desired dimension, such as for example nanoparticles. In some embodiments, the stabilizing agents may include, but are not limited to, surfactants, emulsifiers, gelling agents, thickening agents, polymeric stabilizers (e.g., polymeric peptides, biguanides, polybiguanides, imine-functionalized chelates, polyvinylpyrrolidone, polyethylene oxide and polyethylene oxide copolymers, natural gums, acetylated glycerides, polysaccharide based polymers and surfactants, polyols, protein-based polymers, and silicon-based polymers), Pickering agents, or combinations thereof.

The methods according to the second aspect may enable control of the number of nucleation sites and growth of oxidized metal compounds during the co-deposition product producing step. For example, it is believed that either decreasing the amount of ions of the metal or increasing the amount of silicate ions in the alkali oxidant-silicate solution increases the relative number of nucleation sites and moderates the growth of oxidized species of a metal during the co-deposition product producing step. In other words, by varying the ratio of metal ions to silicate ions in the alkali co-deposition solution, control over the growth and resulting physical dimensions of the oxidized species of a metal may be achieved.

In some embodiments, the co-deposition product producing step may be performed at relatively low temperature, since co-deposition product may experience increasing solubility with increasing temperature. In some embodiments, the co-deposition product producing step may be performed at a temperature less than about 95 degrees Celsius. In some embodiments, the co-deposition product producing step may be performed at a temperature between about 1 degree Celsius and about 85 degrees Celsius. In some embodiments, the co-deposition product producing step may be performed at a temperature between about 15 degrees Celsius and about 25 degrees Celsius.

In a third aspect, the invention is a method for producing a multi-layered co-deposition product, wherein the multi-layered co-deposition product comprises two or more layers of a co-deposition product comprising at least one oxidized species of a metal attached to silica, the method comprising the steps of:
(a) providing a silicate solution comprising an amount of silicate ions;
(b) adding an amount of ions of the metal to the alkali co-deposition solution;
(c) adding an oxidation means to the alkali co-deposition solution;
(d) facilitating oxidation in the alkali co-deposition solution of the ions of the metal by the oxidation means forming the at least one oxidized species, thereby catalyzing polymerization of the silicate ions in a locus of the at least one oxidized species to produce a layer; and
(e) repeating steps (b)-(d), as required, to form the multi-layered co-deposition product.
   Accordingly, the method according to the third aspect may comprise alternating addition of the ions of the metal and the oxidation means, in the presence of silicate ions, towards the formation of a multi-layered co-deposition product having oxidized metal-silica layers.

In a fourth aspect, the invention is a co-deposition product comprising at least one oxidized species of a metal attached to silica polymers.

In some embodiments, the metal may comprise an oligodynamic metal and the co-deposition product may be useful, for example, as components for electronics, food and agriculture products, medical devices, drugs, drug carriers, and cosmeceuticals. In some embodiments, the co-deposition product may have specific anti-microbial, anti-biofilm, and anti-fouling properties.

In some embodiments, the metal comprises silver and the co-deposition product comprises an oligodynamic oxidized silver species comprising a silver salt and a silver oxide. The co-deposition product may comprise any oxidized silver species such as silver salts, silver oxide (Ag₂O), argentic oxide (AgO), trisilver tetraoxide (Ag₃O₄), or other forms of oxidized silver such as Ag₂O₂, Ag₄O₄, Ag₂O₃, Ag₇O₈X, or Ag₂OX and other combinations of AgₐO_{b}XY, where X is an anion. The anion X may comprise a single anion or a plurality of different anions. The anions may therefore comprise any anion or combination of anions. X may include an anion such as nitrate, sulfate, chloride, phosphate, carbonate, iodate, fluoride, perchlorate or related species, and Y may include cations such as a proton, a hydronium ion, sodium, potassium, lithium, calcium, barium, or related species. The oxidized silver species may further comprise Ag₂SO₄.

The total silver in the co-deposition product can be any amount of silver. In some embodiments, the total silver in the co-deposition product may range between about 0.1 mg Ag/cm² and about 50.0 mg Ag/cm². In some embodiments, the total silver in the co-deposition product may range between about 0.1 mg Ag/cm² and about 2.5 mg Ag/cm², which may effect a greater than 99% killing of Gram positive bacteria, Gram negative bacteria, and bio-film microbes within 4-hours.

In some embodiments, the co-deposition product comprises copper and the co-deposition product comprises an oligodynamic oxidized copper species comprising a copper salt and a copper oxide.

In some embodiments, the co-deposition product may have different surface characteristics and hydrophobicity than the oxidized metal species alone. Further, the silica may provide a site for adding chemical functional groups that may subsequently be used for covalent adhesion of co-deposition products to a substrate.

Embodiments of the present invention are described in the following Examples, which are set forth to aid in the understanding of the invention, and should not be construed to limit in any way the scope of the invention as defined in the claims which follow thereafter.

### Example 1

The following is a non-limiting example of an embodiment of a method according to the first aspect of the invention. At 25 degrees Celsius, a 99.2 mL solution of 4.1 wt/wt % K₂S₂O₈ (7.52 mmoles of persulfate) in distilled water was stirred with a magnetic stirrer creating a vortex in the mixing vessel. To this stirring solution, 0.185 mL of K₂SiO₃ (1.39 g/ml, 12.7 wt/wt % K₂O, 26.5 wt/wt % SiO₂, pH 12.7), at 25 degrees Celsius, was added dropwise to the potassium persulfate solution. The aqueous solution was stirred for 5 minutes producing a clear colorless solution. To this stirring solution, an Ag⁺ solution held at 25 degrees Celsius, containing 59.3 wt % AgNO₃ (1.68 ml, 8.72 mmoles Ag) was added dropwise into the vortex of the stirring solution, completing the addition of the entire volume of silver nitrate over the course of 60 seconds. During this time, the solution turned a bright yellow/opalescent color. Upon further addition of silver, the translucent yellow solution turned turbid, transitioning from yellow-orange to red then brown after half of the silver was added (25 seconds). The turbid brown solution became black and turbid by the end of silver addition. After silver addition was complete, the temperature of the solution remained at 25 degrees Celsius and the solution was continually stirred with a mechanical stirrer for a total time of 30 minutes. The color of the solution did not change during this mixing time, where the final solution appeared black and turbid. After 30 minutes of reaction, the pH of the solution was 2.0, the mechanical stirrer was turned off, and the reaction solution was left for a period of 5 minutes to permit settling of the precipitate. After 5 minutes, the supernatant was filtered through a 40 ashless filter paper in a Buchner funnel using vacuum filtration. Three times 10 ml of distilled water was used to rinse the precipitate followed by 2 minutes of settling to filter off the supernatant each rinse. Upon the last rinse, the precipitate was transferred onto the filter paper and was subsequently rinsed with three times 10 ml of acetone (95 vol. %) and filtered by vacuum under 22 mmHg for 5 minutes to dry the solid black co-deposition product. The product was dried for a period of 12 hours to afford a steady dry mass of 0.773 g grey-black dull powder.

Analysis by X-ray diffractometer determined that the co-deposition product included Ag₇NO₁₁, AgO, and Ag₂SO₄. The amount of total silver within the co-deposition product was estimated at about 75.9 wt/wt % Ag ([Ag₇NO₁₁, AgO, Ag₂SO₄]@SiO₂). Antimicrobial activities (bactericidal and anti-biofilm) were tested against Pseudomonas aeruginosa and Staphylococcus aureus. Single-time log reduction (n=3) for a mass of the isolated co-deposition product, equivalent to equal 10 mg Ag was performed in-vitro. 1-hour log reduction against Pseudomonas aeruginosa and 4-hour log reduction against Staphylococcus aureus resulted in a >99% and >99.9% log reduction respectively vs. a minimum 7 log CFU/ml control. Single-time anti-biofilm log reduction (n=3) were tested against Staphylococcus aureus biofilms. A mass of the isolated co-deposition product, equivalent to equal 10 mg Ag, was added to a mature Staphylococcus aureus biofilm for a period of 4 hours resulting in a >99% log reduction vs. a minimum 8 log CFU/ml control biofilm.

The methods according to the first aspect may further comprise, following the co-deposition product producing step, the step of isolating the co-deposition product. In embodiments that provide the alkali co-deposition solution by adding silver nitrate to an alkali chemical oxidant-silicate solution, isolation may occur anywhere after about 1 to about 90 minutes after the addition of silver nitrate. In some embodiments, isolation may occur after 30 minutes. In some embodiments, isolation may occur after 60 minutes.

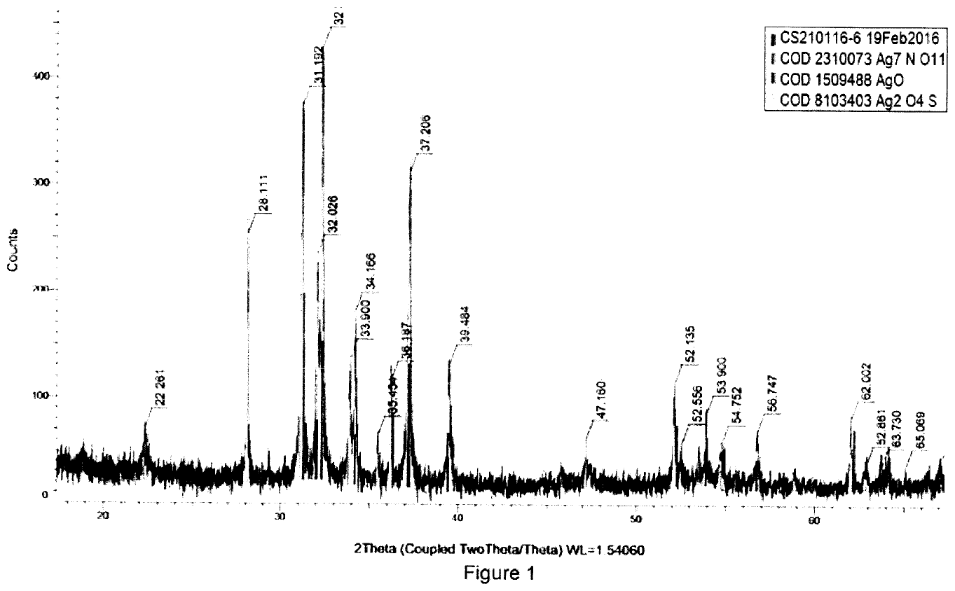

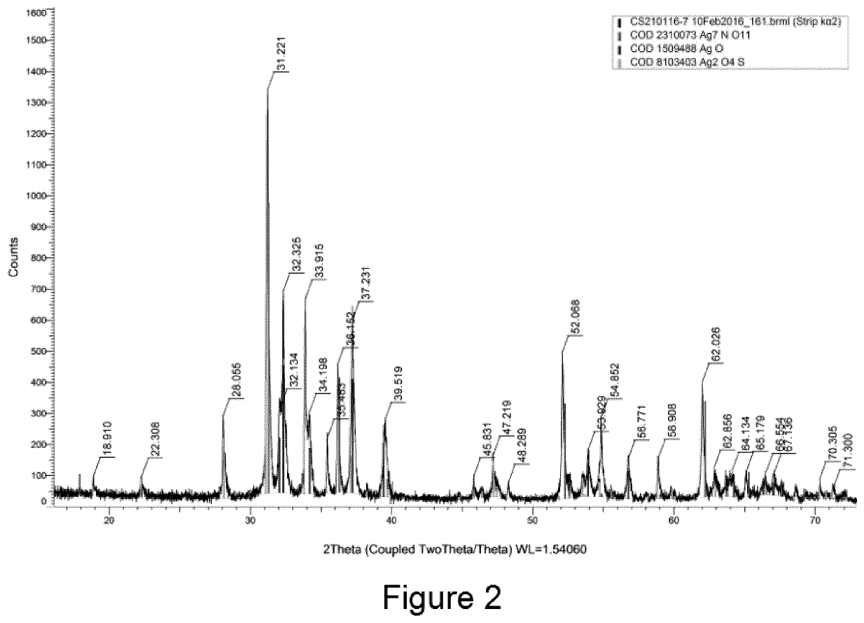

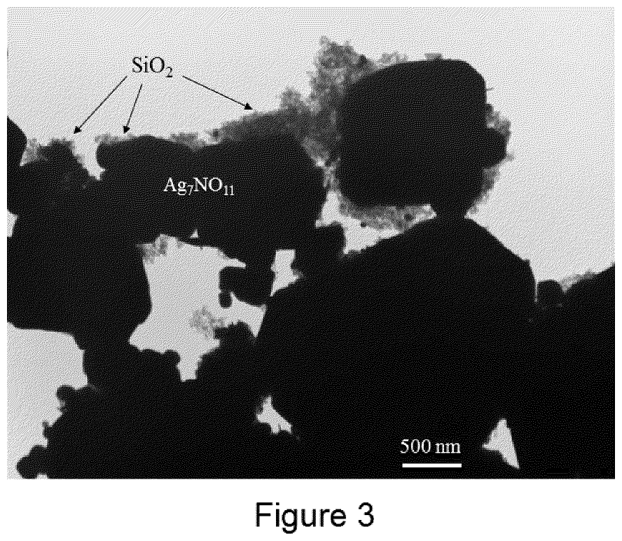

The methods according to the first aspect may provide that the order of reagent addition may control the composition of silver oxide compounds present in the co-deposition product. Referring to FIG. 1, the addition of alkaline silicate solutions simultaneously with oxidation of silver ions can result in a greater proportion of argentic oxide to silver oxynitrate in the co-deposition product, as observed in the shown XRD spectra. Referring now to FIG. 2, the controlled addition of aqueous silver solutions to a solution containing the chemical oxidizing agent and silicate ions produced greater ratio of silver oxynitrate, as observed in the shown XRD spectra and TEM in FIG. 3.

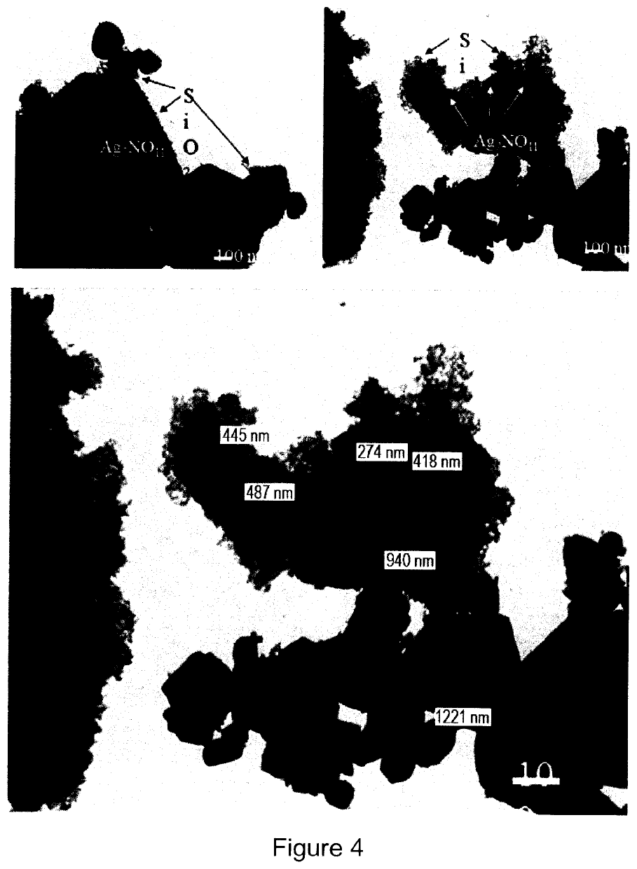

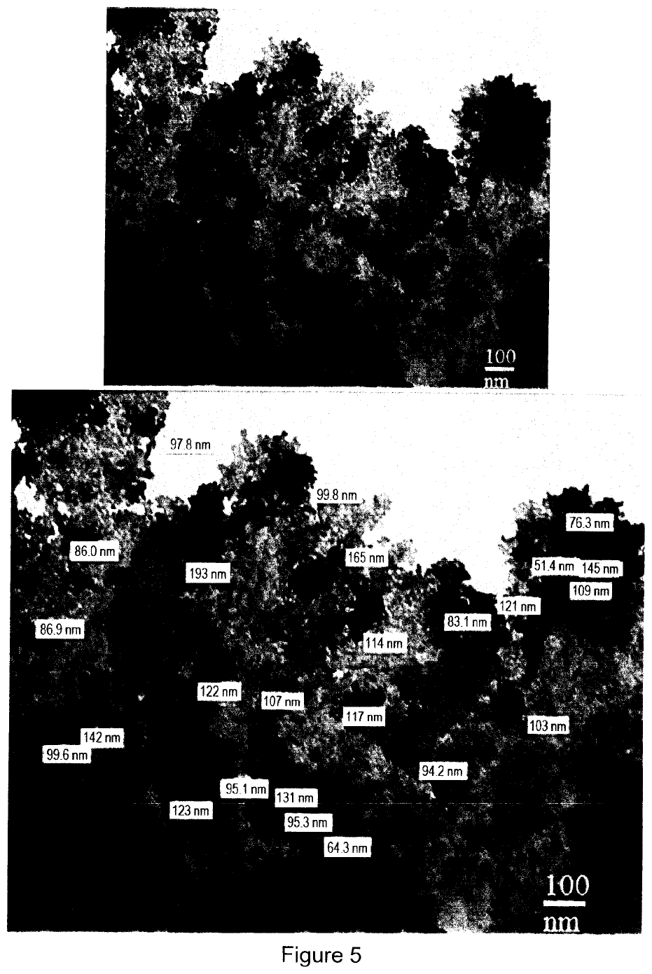

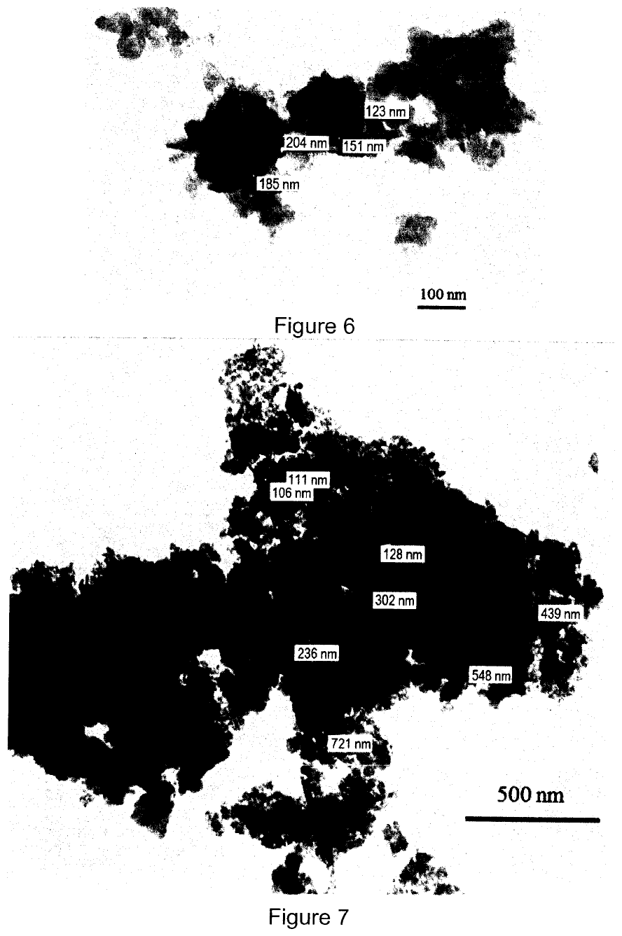

Silicate polymerization may slow the nucleation and growth of silver oxynitrate. Accordingly, in varying the relative concentration of silicate ions compared to silver ions in the alkali co-deposition solution, it may be possible to control the size of silver oxide and oxidized silver salts formed by the invention. For example, including silicate ions in the alkali co-deposition solution may enable the isolation of silver oxide salt nanoparticles. In some embodiments, increasing the ratio of alkali silicates from 1:0.1 of Ag: SiO₂ to 1:0.6 of Ag: SiO₂, as shown in FIGS. 4-7, may decrease the average crystalline size of silver oxides in the co-deposition product and may increase the amount of silica attached to the oxidized silver species.

### Example 2

The following is an example of an embodiment of a method according to the first aspect of the invention, in which the nucleation and growth of oxidized silver species may have been slowed by increasing the silicate concentration and decreasing the amount of time the co-deposition product production step occurred. At 25 degrees Celsius, a 99.2 mL solution of 4.1 wt/wt % K₂S₂O₈ (7.52 mmoles of persulfate) in distilled water was stirred with a magnetic stirrer creating a vortex in the mixing vessel. To this stirring solution, 1.48 mL of K₂SiO₃ (1.39 g/ml, 12.7 wt/wt % K₂O, 26.5 wt/wt % SiO₂, pH 12.7), at 25 degrees Celsius, was added dropwise to the potassium persulfate solution. The aqueous solution was stirred for 10 minutes, producing a clear colorless solution. To this stirring solution, an Ag⁺ solution held at 25 degrees Celsius, containing 59.3 wt % AgNO₃ (1.68 ml, 8.72 mmoles Ag) was added dropwise into the vortex of the stirring solution, completing the addition of the entire volume of silver nitrate over the course of 30 seconds. During the addition of Ag⁺, the solution turned from a clear to bright yellow opalescent translucent solution, then to a turbid peach/white solution, and then to a turbid red/brown color within the time of silver addition. After 5 minutes of reaction, the pH of the solution was 5.0 and the reaction was complete. The mechanical stirrer was turned off and the reaction solution was filtered immediately through a 40 ashless filter paper in a Buchner funnel using vacuum filtration. The precipitate was rinsed three times with 10 mL of distilled water and subsequently rinsed with three times 10 ml of acetone (95 vol. %) and filtered by vacuum under 22 mmHg for 5 minutes to dry the tan-grey powder co-deposition product. The product was dried for a period of 12 hours to afford a steady dry mass of 0.137 g tan-grey powder.

No diffraction peaks were observed by X-ray diffractometer of the co-deposition product. The amount of total silver within the co-deposition product was estimated at about 46.5 wt/wt % Ag ([AgₓO_{y}]@SiO₂). Analysis by transmission electron microscopy demonstrated an average crystalline size of the oxidized metal core in the co-deposition product of 29.1±9.2 nm.

In some embodiments, prior to the co-deposition product producing step, a stabilizing agent may be added to the alkali co-deposition solution to stabilize the co-deposition product produced. Preferably, the stabilizing agent is present in a concentration less than about 0.1 M, more preferably at concentrations less than about 0.05 M.

### Example 3

The following is a non-limiting example of an embodiment of a method according to the first aspect of the invention, in which a stabilizing agent, polyvinylpyrrolidone 10,000 (“PVP”), is included in the alkali co-deposition solution. At 25 degrees Celsius, a 99.2 mL solution of 4.1 wt/wt % K₂S₂O₈ (7.52 mmoles of persulfate) in distilled water was stirred with a magnetic stirrer creating a vortex in the mixing vessel. To this stirring solution, 0.173 g of PVP was added at 25 degrees Celsius. The solution was left to stir for 5 minutes until the PVP was entirely dissolved forming a clear very pale yellow solution. 0.27 mL of K₂SiO₃ (1.39 g/ml, 12.7 wt/wt % K₂O, 26.5 wt/wt % SiO₂, pH 12.7) at 25 degrees Celsius, was added dropwise to the PVP-potassium persulfate solution. The aqueous solution was stirred for 5 minutes, producing a very pale yellow colorless solution. To this stirring solution, an Ag⁺ solution held at 25 degrees Celsius, containing 59.3 wt % AgNO₃ (1.68 ml, 8.72 mmoles Ag) was added dropwise into the vortex of the stirring solution, completing the addition of the entire volume of silver nitrate over the course of 60 seconds. During the addition of Ag⁺, the solution turned a turbid pale-yellow/white. Upon further addition of silver, the solution maintained turbidity but transitioned from to a peach hue, then red, then brown at the end of silver addition. After silver addition was complete, the temperature of the solution remained at 25 degrees Celsius and the solution was stirred continuously with a mechanical stirrer for a total time of 30 minutes. After about 5 minutes of reaction, the solution became black and opaque/turbid. This color change did not alter over the remainder of the mix time. After 30 minutes of reaction, the pH of the solution was 2.0, the mechanical stirring was turned off, and the reaction solution was left for a period of 5 minutes to permit settling of the precipitate. After 5 minutes, the supernatant was filtered through a 40 ashless filter paper in a Buchner funnel using vacuum filtration. Three times 10 ml of distilled water was used to rinse the precipitate, followed by 2 minutes of settling to filter off the supernatant each rinse. Upon the last rinse, the precipitate was transferred onto the filter paper and was subsequently rinsed with three times 10 ml of acetone (95 vol. %) and filtered by vacuum under 22 mmHg for 5 minutes to dry the solid black co-deposition product. The product was dried for a period of 12 hours to afford a steady dry mass of 1.168 g grey-black dull powder.

Analysis by X-ray diffractometer determined that the co-deposition product included Ag₇NO₁₁, AgO, and Ag₂SO₄. The amount of total silver within the co-deposition product was estimated at about 58.4 wt/wt % Ag ([Ag₇NO₁₁, AgO, Ag₂SO₄]@SiO₂). Analysis by transmission electron microscopy demonstrated an average crystalline size of the oxidized metal core in the co-production product of 131±86 nm.

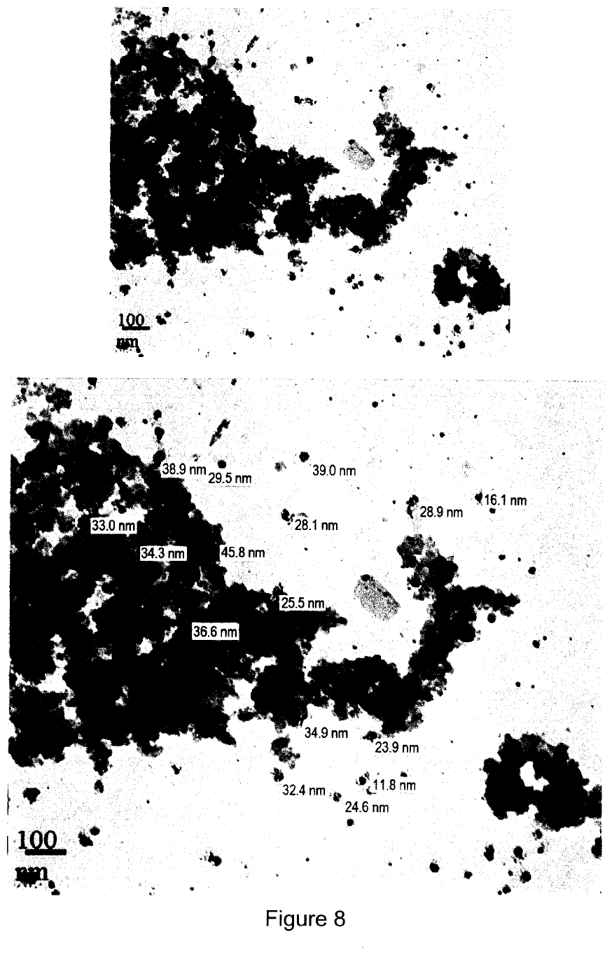

Referring now to FIG. 8, utilizing a stabilizing agent in combination with isolating the co-deposition product relatively quickly after the addition of silver nitrate, can result in the formation of co-deposition products where the size of the oxidized silver species (i.e., the oxidized silver species without silica attachment) is relatively small. In some embodiments, the size of the oxidized silver species may have a size less than 100 nm. In some embodiments, the co-deposition product producing step may be performed about 1 minute to about 30 minutes after silver nitrate addition, more preferably less than about 10 minutes.

According to a second aspect, methods are provided for the production of a composite material comprising a substrate and a co-deposition product, wherein the co-deposition product comprises at least one oxidized species of a metal that is attached to silica.

In some embodiments, the methods according to the second aspect may comprise, first, contacting the substrate with a metal ion solution comprising an amount of ions of the metal. Subsequent to the first contacting step, some embodiments of the methods may comprise a second contacting step of contacting the substrate with an alkali oxidant-silicate solution comprising an amount of silicate ions and an oxidation means. The methods may comprise a third step, a co-deposition product producing step, of facilitating oxidation in the alkali oxidant-silicate solution of the ions of the metal by the oxidation means, which may form the at least one oxidized species, thereby catalyzing polymerization of the silicate ions in the locus of the at least one oxidized species and forming the silica, and thereby producing the composite material.

In some embodiments, the pH of the metal ion solution used in the first contacting step may have a pH in the range of about 5 to about 9.

The methods according to the second aspect may further comprise, following the co-deposition product production step, the step of removing unfixed material from the substrate. In some embodiments, the removing of unfixed material comprises a rinsing or agitation step.

The methods according to the second aspect may further comprise the step, prior to the first contacting step, of etching the substrate to increase the roughness of the substrate surface, increasing the surface area for adhesion and co-deposition of the co-deposition product on the substrate. More particularly, techniques of etching may, for example, include alkali, solvent, acid, corona plasma, flame, UV, mechanical abrasion, or a combination thereof.

In some embodiments, the composite material may be produced by, first, exposing the substrate to a silver nitrate solution having a concentration in the range of about 0.01 M to about 5.1 M. Second, the substrate can be exposed to an alkali oxidant-silicate solution comprising potassium persulfate and potassium silicate. In some embodiments, the potassium persulfate may have a concentration in the range of about 0.01 to about 0.17 M. In some embodiments, the potassium persulfate concentration may be greater than about 0.05 M. In some embodiments, the potassium persulfate concentration may be about 0.16 M. In some embodiments, the potassium silicate may have a concentration in the range of about 0.01 to about 0.18 M.

In some embodiments, the oxidation of the silver ions by the persulfate may generate a decrease in localized pH in the alkali oxidant-silicate solution forming a reaction zone, which may cause silicate ions in the location of the oxidized silver species to polymerize, resulting in silica attachment to the oxidized silver compounds.

In some embodiments, the composite material may be dried. Drying may be accomplished with the assistance of flowing air, which may drive off volatile solvents. The flowing air may be about room temperature or above. However, in some embodiments, drying temperatures may be kept below 115 degrees Celsius. In some embodiments, drying temperatures may be below 55 degrees Celsius.

In a third aspect, methods are provided for producing a multi-layered co-deposition product, wherein the multi-layered co-deposition product comprises two or more layers of a co-deposition product, wherein the co-deposition product comprises at least one oxidized species of a metal attached to silica.

In some embodiments, the methods of producing a multi-layered co-deposition product may comprise, first, providing silicate solution comprising an amount of silicate ions; second, adding an amount of ions of the metal to the alkali co-deposition solution; third, adding an oxidation means to the alkali co-deposition solution; fourth, facilitating oxidation in the alkali co-deposition solution of the ions of the metal by the oxidation means forming the at least one oxidized species, thereby catalyzing polymerization of the silicate ions in the locus of the at least one oxidized species to produce a layer; and fifth, repeating the first four steps, as required, to form the multi-layered co-deposition product.

In a fourth aspect, the invention is a co-deposition product comprising at least one oxidized species of a metal attached to silica polymers.

In some embodiments, the metal may comprise an oligodynamic metal and the co-deposition product may have specific anti-microbial, anti-biofilm, and anti-fouling properties.

In some embodiments, the metal may comprise silver and the co-deposition product may comprise an oligodynamic oxidized silver species comprising a silver salt and a silver oxide. In some embodiments, the co-deposition product comprises copper and the co-deposition product comprises an oligodynamic oxidized copper species comprising a copper salt and a copper oxide.

In some embodiments, the co-deposition product may have different surface characteristics and hydrophobicity than the oxidized metal species alone. Further, the silica may provide a site for adding chemical functional groups that may subsequently be used for covalent adhesion of co-deposition products to a substrate.

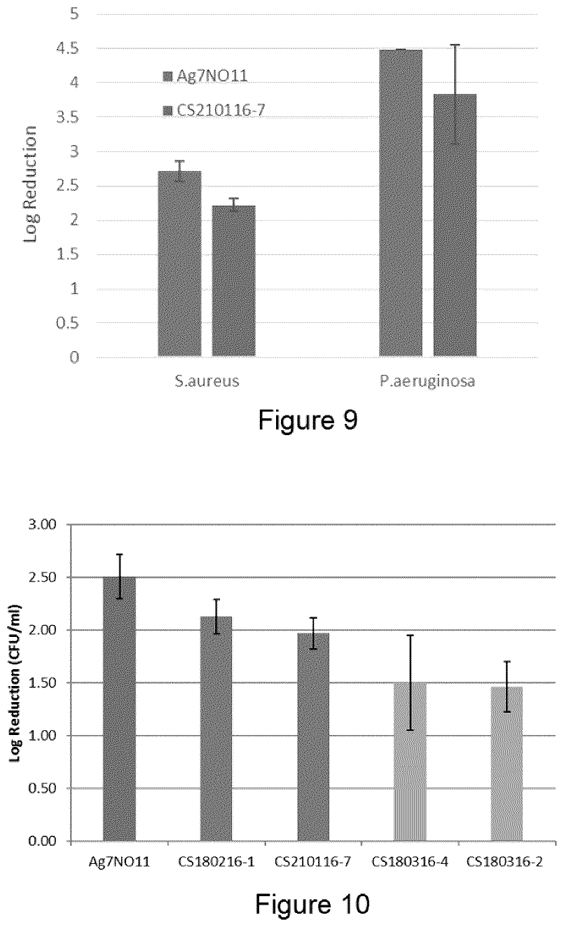

Embodiments of co-deposition products according to the fourth aspect may demonstrate anti-microbial and anti-biofilm activity. Referring now to FIG. 9, the anti-microbial activity of co-deposition products in comparison to the anti-microbial activity of unattached silver oxynitrate can be evaluated by performing a 1-hour log reduction against Pseudomonas aeruginosa and 4-hour log reduction against Staphylococcus aureus (with an equivalent 10 mg Ag for both co-deposition product and unattached silver oxynitrate). Co-deposition products exhibit less activity than silver oxide salts against S. aureus (α=0.009), but may still afford a 99% log reduction within 4 hours exposure. Further, co-deposition products can exhibit comparable antimicrobial activity in comparison to silver oxide salts when evaluated against P. aeruginosa for a 1-hour exposure time.

### Example 4

The following is a non-limiting example of how an embodiment of a co-deposition product according to the fourth aspect of the invention may be relatively stable. A 0.105 g sample of the co-deposition product ([Ag₇NO₁₁, AgO, Ag₂SO₄]@SiO₂, 75.87 wt/wt % Ag) was added into 4.005 g of soft paraffin/Paraffin wax or multi-hydrocarbon (petroleum jelly) in a mortar and pestle at 25 degrees Celsius. The materials were blended by agitation with the pestle over 30 minutes until a homogenous grey-black translucent formulation was obtained and isolated in a glass vial and stored under accelerated aging conditions (40 degrees Celsius, 15% Relative Humidity) for a period of 7 days.

Analysis by X-ray diffractometer determined that the co-deposition product included Ag₇NO₁₁, AgO, and Ag₂SO₄. The amount of total silver within the ointment was estimated at about 1.9 wt/wt % Ag ([Ag₇NO₁₁, AgO, Ag₂SO₄]@SiO₂ Ointment). As shown in FIG. 10, antimicrobial activities were tested against Staphylococcus aureus biofilms. Single-time anti-biofilm log reduction (n=3) were tested against Staphylococcus aureus biofilms. A mass of the isolated co-deposition product, equivalent to equal 10 mg Ag, was added to a mature Staphylococcus aureus biofilm for a period of 4 hours resulting in a >95% log reduction vs. a minimum 8 log CFU/ml control biofilm.

1. A method for producing a co-deposition product comprising at least one oxidized species of a metal attached to silica, the method comprising the steps of:
(a) providing an alkali co-deposition solution comprising an amount of ions of the metal, an amount of silicate ions, and an oxidation means; and
(b) producing the co-deposition product by facilitating oxidation in the alkali co-deposition solution of the ions of the metal by the oxidation means forming the at least one oxidized species, thereby catalyzing polymerization of the silicate ions in a locus of the at least one oxidized species and forming the silica.

2. The method of claim 1, wherein step (a) comprises:
(i) providing an alkali oxidant-silicate solution comprising the amount of silicate ions and the oxidation means; and
(ii) adding the amount of metal ions to the alkali oxidant-silicate solution to produce the alkali co-deposition solution.

3. The method of claim 1, wherein step (a) comprises:
(i) providing an alkali metal-silicate solution comprising the amount of silicate ions and the amount of metal ions; and
(ii) adding the oxidation means to the alkali metal-silicate solution to produce the alkali co-deposition solution.

4. The method of claim 1, wherein the metal comprises an oligodynamic metal.

5. The method of claim 1, wherein the metal comprises silver and the ions of the metal comprise silver ions.

6. The method of claim 1, wherein the metal comprises copper and the ions of the metal comprise copper ions.

7. The method of claim 5, wherein the alkali co-deposition solution comprises an aqueous solution of a silver salt.

8. The method of claim 7, wherein the silver salt comprises silver nitrate.

9. The method of claim 1, wherein the alkali co-deposition solution has a pH ranging from about 10 to about 14.

10. The method of claim 9, wherein the alkali co-deposition solution has a pH ranging from about 10 to about 12.

11. The method of claim 1, wherein the alkali co-deposition solution comprises a strong alkali compound.

12. The method of claim 11, wherein the strong alkali compound comprises alkali effecting ions.

13. The method of claim 12, wherein the alkali effecting ions are selected from sodium, potassium, lithium, rubidium, cesium, francium, or a mixture thereof.

14. The method of claim 1, wherein the alkali co-deposition solution comprises an aqueous solution of an alkali metal-silica salt.

15. The method of claim 11, wherein the amount of strong alkali compound is selected to be a stoichiometrically excess amount relative to the amount of silicate ions.

16. The method of claim 1, wherein the oxidizing means comprises an oxidizing agent.

17. The method of claim 16, wherein the oxidizing agent is selected from persulfate, permanganate, periodate, perchlorate, peroxide, ozone, or a mixture thereof.

18. The method of claim 17, where in the oxidizing agent comprises persulfate or ozone.

19. The method of claim 1, wherein the oxidizing means comprises an electrochemical assembly comprising a working electrode.

20. The method of claim 19, wherein the working electrode is polarized to a potential (E) in the range of 0.6 to 2.1 vs. standard hydrogen electrode.

21. The method of claim 19, wherein the working electrode is polarized to a potential (E) in the range of 1.74 to 1.77 vs. standard hydrogen electrode.

22. The method of claim 1, further comprising the step of adding an amount of a source of anions to the co-deposition solution for combining with the ions of the metal to produce the co-deposition product.

23. The method of claim 1, wherein the co-deposition comprises a stabilizing agent to stabilize the co-deposition product.

24. The method of claim 23, wherein the stabilizing agent is selected from a surfactant, an emulsifier, a gelling agent, a thickening agent, a polymeric stabilizer, a Pickering agent, or a mixture thereof.

25. The method of claim 1, wherein the co-deposition product producing step comprises agitating the co-deposition solution during at least a portion of the co-deposition product producing step.

26. The method of claim 1, further comprising after step (b), the step of isolating the co-deposition product.

27. The method of claim 26, further comprising the step of re-suspending the co-deposition product in a solvent and depositing the co-deposition product onto a substrate by a deposition means.

28. The method of claim 27, wherein the deposition means is selected from air-knife blowing, rotogravure printing, dipping, rolling, screening, slot-die coating, spraying, spinning, printing, or a combination thereof.

29. The method of claim 26, further comprising the step of producing a formulation by incorporating the co-deposition product into a formulation substance.

30. The method of claim 29, wherein the formulation substance is selected from an oil, a surfactant, an emulsifier, a thickener, a gelling agent, a filler, an excipient, an active ingredient, or a mixture thereof; a thermoplastic polymer; or a curable polymer.

31. The method of claim 26, further comprising the step of adding chemical functional groups to the silica of the co-deposition product.

32. The method of claim 31, wherein the chemical functional groups comprise alkoxysilanes, halosilanes, or a combination thereof.

33. The method of claim 31, further comprising the step of bonding the co-deposition product to a substrate by facilitating a chemical reaction between the chemical functional groups and the substrate.

34. A method for producing a composite material comprising a substrate and a co-deposition product, wherein the co-deposition product comprises at least one oxidized species of a metal attached to silica, the method comprising the steps of:
(a) first contacting the substrate with a metal ion solution comprising an amount of ions of the metal; and
(b) second contacting the substrate with an alkali oxidant-silicate solution comprising an amount of silicate ions and an oxidation means; and
(c) producing the co-deposition product during step (b) by facilitating oxidation in the alkali oxidant-silicate solution of the ions of the metal by the oxidation means forming the at least one oxidized species, thereby catalyzing polymerization of the silicate ions in a locus of the at least one oxidized species and forming the silica, and thereby producing the composite material.

35. The method of claim 34, further comprising after step (c), the step of washing the composite material.

36. The method of claim 34, further comprising before step (a), the step of etching the substrate.

37. The method of claim 34, wherein the metal is an oligodynamic metal.

38. The method of claim 34, wherein the metal comprises silver and the ions of the metal comprise silver ions.

39. The method of claim 34, wherein the metal comprises copper and the ions of the metal comprise copper ions.

40. The method of claim 38, wherein the metal ion solution comprises an aqueous solution of a silver salt.

41. The method of claim 40, wherein the silver salt comprises silver nitrate.

42. The method of claim 34, wherein the alkali oxidant-silicate solution has a pH ranging from about 10 to about 14.

43. The method of claim 42, wherein alkali oxidant-silicate solution has a pH ranging from about 10 to about 12.

44. The method of claim 34, wherein alkali oxidant-silicate solution comprises a strong alkali compound.

45. The method of claim 44 wherein the strong alkali compound comprises alkali effecting ions.

46. The method of claim 45, wherein the alkali effecting ions are selected from sodium, potassium, lithium, rubidium, cesium, francium, or a mixture thereof.

47. The method of claim 34, wherein the alkali oxidant-silicate solution comprises an aqueous solution of a silica salt of an alkali metal element ion.

48. The method of claim 43, wherein the amount of strong alkali compound is selected to be a stoichiometrically excess amount relative to the amount of silicate ions.

49. The method of claim 34, wherein the oxidizing means comprises an oxidizing agent.

50. The method of claim 49, wherein the oxidizing agent is selected from persulfate, permanganate, periodate, perchlorate, peroxide, ozone, or a mixture thereof.

51. The method of claim 50, where in the oxidizing agent comprises persulfate or ozone.

52. The method of claim 34, wherein the oxidizing means comprises an electrochemical assembly comprising a working electrode that is polarized.

53. The method of claim 52, wherein the working electrode is polarized to a potential (E) in the range of 0.6 to 2.1 vs. standard hydrogen electrode.

54. The method of claim 52, wherein the working electrode is polarized to a potential (E) in the range of 1.74 to 1.77 vs. standard hydrogen electrode.

55. The method of claim 34, further comprising the step of adding an amount of a source of anions to the alkali oxidant-silicate solution for combining with the ions of the metal in order to produce the co-deposition product.

56. The method of claim 34, wherein the alkali oxidant-silicate solution comprises a stabilizing agent for stabilizing the co-deposition product.

57. The method of claim 56, wherein the stabilizing agent is selected a surfactant, an emulsifier, a gelling agent, a thickening agent, a polymeric stabilizer, a Pickering agent, or a mixture thereof.

58. The method of claim 34, further comprising after step (c), the step of removing unbound material from the composite material.

59. A method for producing a multi-layered co-deposition product, wherein the multi-layered co-deposition product comprises two or more layers of a co-deposition product comprising at least one oxidized species of a metal attached to silica, the method comprising the steps of:
(a) providing an alkali co-deposition solution comprising an amount of silicate ions;
(b) adding an amount of ions of the metal to the alkali co-deposition solution;
(c) adding an oxidation means to the alkali co-deposition solution; and
(d) facilitating oxidation in the alkali co-deposition solution of the ions of the metal by the oxidation means forming the at least one oxidized species, thereby catalyzing polymerization of the silicate ions in a locus of the at least one oxidized species to produce a layer; and
(e) repeating steps (b)-(d), as required, to form the multi-layered co-deposition product.

60. A co-deposition product comprising at least one oxidized species of a metal, the at least one oxidized species attached to silica.

61. The co-deposition product of claim 60, wherein the metal comprises an oligodynamic metal and the co-deposition product comprises an antimicrobially active oxidized species of the metal.

62. The co-deposition product of claim 61, wherein the metal comprises silver and the co-deposition product comprises an antimicrobially active oxidized silver species comprising a silver salt and a silver oxide.

63. The co-deposition product of claim 61, wherein the metal comprises copper and the co-deposition product comprises an antimicrobially active oxidized copper species comprising a copper salt and a copper oxide.
